(19) United States
(12) Patent Application Publication
(10) Pub. No.: US 2021/0064428 A1
(43) Pub. Date: Mar. 4, 2021

(54) RESOURCE OPTIMIZATION WITH SIMULTANEOUS TRUST REGION MODELING

(71) Applicant: Uber Technologies, Inc., San Francisco, CA (US)

(72) Inventors: David Mikael Eriksson, Karlstad (SE); Michael Arthur Leopold Pearce, Staffordshire (GB); Jacob Gardner, San Francisco, CA (US); Ryan Darby Turner, San Francisco, CA (US); Matthias Ullrich Poloczek, San Francisco, CA (US)

(21) Appl. No.: 17/010,725

(22) Filed: Sep. 2, 2020

Related U.S. Application Data
(60) Provisional application No. 62/895,318, filed on Sep. 3, 2019.
(60) Provisional application No. 62/923,997, filed on Oct. 21, 2019.

(51) Int. Cl. G06F 9/50

(52) U.S. Cl. CPC G06F 9/50

(57) ABSTRACT

A transport service system comprises a plurality of drivers and riders over a plurality of cities. A resource allocation function using a plurality of variables associated with incentives that may be provided to the drivers and riders over the cities with an output describing a profitability of the system. The system evaluates an initial set of results for an initial set of randomized candidates according to a resource allocation function. The system generates a plurality of local models. Each local model is a Gaussian process posterior distribution over a trust region centered around a randomized candidate. The system samples a function from each distribution and identifies a candidate with an optimal result according to the sampled function. The system evaluates the best candidate chosen from among the identified candidates with the resource allocation function. The system then identifies an optimal solution from the evaluations and distributes resources according to the optimal solution.

### CROSS REFERENCE TO RELATED APPLICATIONS

This application claims the benefit of U.S. Provisional Application No. 62/895,318, filed Sep. 3, 2019 and U.S. Provisional Application No. 62/923,997, filed Oct. 21, 2019, each of which is incorporated by reference in its entirety.

### BACKGROUND

This present disclosure generally relates to an optimization technique particularly implemented in a resource allocation objective function.

Several systems perform optimization in high dimensions to optimize resources allocated, for example, robotic control systems, autonomous vehicles, or online systems. When allocating resources, a resource allocation objective function can broadly describe a plethora of variables that affect an output by the resource allocation objective function. Due to sheer number of potential variables, the resource allocation objective function could be a high-dimensional function, e.g., greater than 20 variables. Moreover, the resource allocation objective function may not be explicitly defined nor easily solvable for the optimal allocation of resources by a system. Conventional techniques can often use resource allocation functions that are costly to generate or impossible to generate, i.e., the explicit function is not known. Moreover, they produce sub-optimal solutions if local optima are present.

### SUMMARY

Systems according to various embodiments perform optimization in high dimensions to optimize resources allocated. An example system is a transport service system that comprises a plurality of drivers and riders over a plurality of cities. A resource allocation function uses a plurality of variables associated with incentives that may be provided to the drivers and riders over the cities with an output describing a profitability of the system. The system seeks to optimize distribution of resources, e.g., incentives that maximize profitability of the system. The system implements a Bayesian optimization technique utilizing a tailored local modeling described as follows. Although the techniques are described in the context of a transport service system, these techniques are applicable to any computing system that is configured to optimize resources, for example, a control system of a robot, a system configured to move such as a self-driving vehicle, and so on.

The system evaluates an initial set of randomly selected candidates, each given by a vector in the high-dimensional search space. These initial evaluations can be tabulated by the system. The system generates a plurality of local models. In an embodiment, each local model is a Gaussian process posterior distribution over a trust region centered around some previously evaluated candidate. The system samples a realization from each local model's distribution and identifies the next candidate with an optimum under the sampled function. The operations performed with the local models may be done so in parallel by the system. The system achieves enhanced parallelism by drawing multiple realizations from the local models and identifying an optimal candidate for each. The system then distributes resources according to the best allocation found.

In some embodiments, the system performs multiple iterations of the Bayesian optimization technique. In between iterations, the system updates the local models with current evaluations in the trust region. Updating the local model includes updating the Gaussian process posterior distribution with subsequent evaluations and may optionally include evolving the local model's trust region. Evolution of the trust region may include shifting its center to the candidate with the best so far result. Evolution also may include adjusting a shape of the trust region including adjusting a size, reshaping the trust region, or some other transformation.

### BRIEF DESCRIPTION OF THE DRAWINGS

FIG. 1 illustrates a networking environment for an online system, in accordance with one or more embodiments.

FIG. 2 illustrates an exemplary architecture of a resource allocation system, in accordance with one or more embodiments.

FIG. 3 illustrates a one-dimensional (1D) example evolution of a Gaussian process posterior distribution according to a Gaussian process, in accordance with one or more embodiments.

FIG. 4 illustrates a two-dimensional (2D) example evolution of a trust region for a local model, in accordance with one or more embodiments.

FIG. 5 illustrates a one-dimensional (1D) example of optimization with a Gaussian process posterior distribution implementing Thompson sampling, in accordance with one or more embodiments.

FIG. 6 illustrates a flowchart for resource optimization with trust region modeling, in accordance with one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Environment

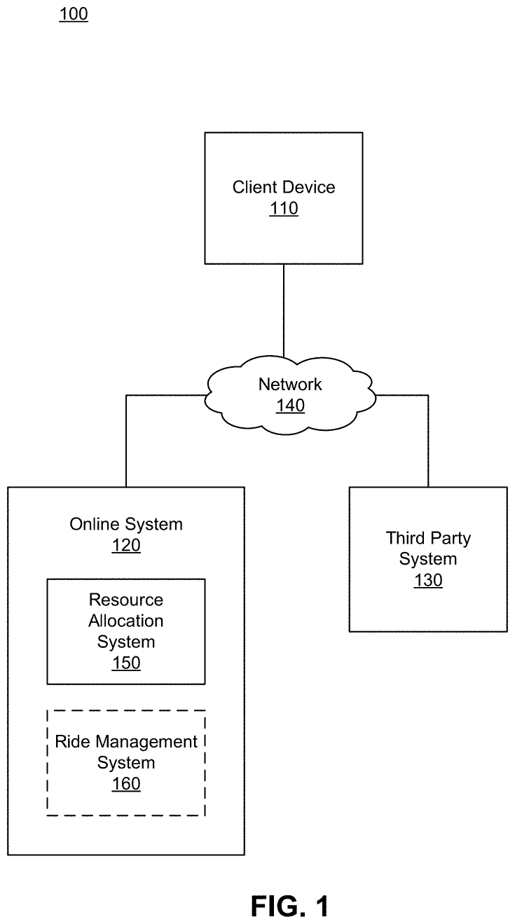

FIG. 1 illustrates networking environment for an online storage system, in accordance with one or more embodiments. FIG. 1 includes a client device 110, an online system 120, a third party system 130, and a network 140. The online system 120 includes a resource allocation system 150 that allocates resources for the online system 120. Resources include budget, personnel, time, other monetary incentives, etc. In some embodiments, the online system 120 is a transport service system that connects riders and drivers for ridesharing transactions. The online system 120, in these embodiments, may also include a ride management system 160 that manages one or more aspects of the ridesharing transactions with each rider and/or driver associated with a client device 110. For clarity, only one client device 110 is shown in FIG. 1, but in reality, multiple client devices 110 may communicate with any component over the network 140. Alternate embodiments of the system environment 100 can have any number online systems 120 and document databases 130. The functions performed by the various entities of FIG. 1 may also vary in different embodiments.

Users interact with the online system 120 through the client device 110. The client device 110 can be personal or mobile computing devices, such as smartphones, tablets, or notebook computers. The client device 110 may interact with the online system 120 through client applications configured to interact with the online system 120.

In embodiments of the online system 120 as a transport service system, users and drivers may interact with the client applications of the client devices 110 to request and access information about rides arranged. The client applications can present information received from the transport service system on a user interface, such as a map of the geographic region, the estimated trip duration, and other information. Additionally, the client devices 110 may provide their location and other data to the transport service system. For example, a current location of a client device 110 may be designated by a user or driver or detected using a location sensor of the client device (e.g., a global positioning system (GPS) receiver) and provided to the transport service system as coordinates. With drivers and riders, the online system 120 can provide incentives to the drivers and riders via the client devices 110 associated with drivers and riders.

The online system 120 allocates resources, e.g., via the resource allocation system 150. The resource allocation system 150 determines how to allocate resources amongst the online system 120. The resource allocation system 150 defines a resource allocation function that inputs a plurality of variables (i.e., the resource allocation function may be high-dimensional) and outputs a score. In defining the resource allocation function, the resource allocation system 150 may determine various interrelationships between the variables which eventually result in the output. In some implementations, the resource allocation function is not explicitly defined, e.g., not have a closed form, and thus be evaluated via a complex simulation. Variables may include incentives to provide to drivers and incentives to provide to riders for a plurality of cities serviced in a transport service system. In other embodiments, variables may further (or rather) include fine-granular resource allocations to specific cohorts of drivers and riders. The output in this embodiment may be a profitability of the transport service system due to the provided incentives across the various drivers and/or riders over the plurality of cities. In other embodiments, the output of the resource allocation function could be another metric, e.g., usage of the transport service system, predicted change in number of drivers and/or riders, etc.

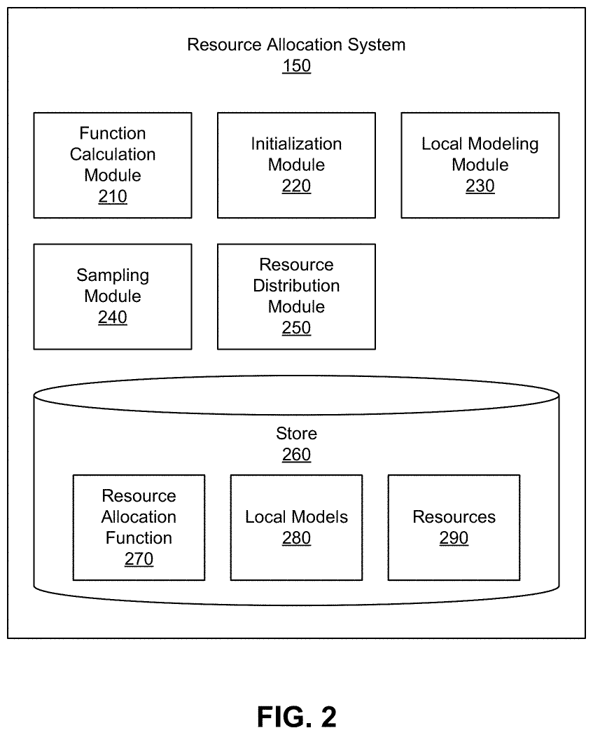

The resource allocation system 150 determines an optimal solution for the variables that optimizes the output of the resource allocation function. The resource allocation function might have a true optimal solution that is not trivially derivable with the resource allocation function. As such, the resource allocation system 150 implements a Bayesian optimization technique with trust region modeling to obtain a best guess of the true optimal solution. The resource allocation system 150 initializes a set of random candidates to evaluate outputs from the budget allocation function. From the initial set of random candidates, the resource allocation system 150 generates a plurality of trust regions. In one embodiment, each trust region is a hypercube centered around a random candidate. The resource allocation system 150 generates a local model for each trust region modeling the budget allocation function within the trust region according to sampled candidates and the corresponding observations in the trust region. The resource allocation system 150, for each trust region, identifies subsequent candidates to evaluate. With the identified subsequent candidates, the resource allocation system 150 evaluates the result for the subsequent candidates with the resource allocation function. The resource allocation system 150 identifies an optimal solution from among all evaluated candidates having the maximal output. According to the optimal candidate, the resource allocation system 150 allocates resources across the online system 120, e.g., distributing incentives to various drivers and/or riders across the plurality of cities. This process of allocating resources will be further described in conjunction with FIGS. 2-7.

In some embodiments, the resource allocation system 150 updates the resource allocation function, e.g., periodically. In practicality, usage by drivers and/or riders of the transport service system constantly changes throughout the course of time. The resource allocation system 150 may update the resource allocation function according to these changes. For example, some drivers can stop usage while other new drivers are added to the transport service system. These changes could affect the interrelationship between variables in the resource allocation function. As another example, the transport service system may add additional cities to be serviced. This could redefine the resource allocation function by adding variables, i.e., increasing dimensionality of the resource allocation function.

In some embodiments, a ride management system 160 manages rideshare transactions. In managing rideshare transactions, the ride management system 160 may implement various algorithms for connecting riders and drivers. Each trip can be logged, e.g., recording a date of the trip, a time of the trip, a route traveled, a rider, a driver, a calculated fare, payment received, discount codes used, any delays, any excess fees, any notes, ratings, other trip information, etc. The ride management system 160 may provide information for a trip all at once or as each piece of information is received or calculated. The ride management system 160 may also log statistics regarding rideshare transactions. The statistics can be used to describe correlative effects between variables and/or metrics, e.g., with regression techniques. For example, there can be a positive linear correlation between incentives provided to drivers in San Francisco, Calif., with profitability in San Francisco, Calif. These correlative effects can be used in defining the resource allocation function, or more generally, the statistics may be used for defining the resource allocation function.

In some embodiments, the third party system 130 provides one or more variables to the online system 120 for the resource allocation function. The third party system 130 may be separate and/or distinct from the online system 120, yet the resource allocation function may include variables from the third party system 130. As such, the third party system 130 may also receive resources from the online system 120, e.g., as an intermediary system to distribute the resources or to consume the resources. For example, the third party system 130 may be an advertising system that distributes advertisements for the online system 120 while receiving compensation (e.g., which may be a resource).

The various components of the system environment 100 communicate via the network 130. The network 130 comprises any combination of local area and wide area networks employing wired or wireless communication links. In some embodiments, all or some of the communication on the network 130 may be encrypted. For example, data encryption may be implemented in situations where the third party system 130 is located on a third-party online system separate from the online system 120.

### Resource Allocation System Architecture

FIG. 2 illustrates an exemplary architecture of the resource allocation system 150, in accordance with one or more embodiments. The resource allocation system 150 allocates resources of the online system 120. In the process of allocating resources, the resource allocation system 150 maintains a resource allocation function and determines an optimal allocation that optimizes an output of the resource allocation function for determining how to allocate resources. The resource allocation system 150 has, among other components, a function calculation module 210, an initialization module 220, a local modeling module 230, a sampling module 240, a resource distribution module 250, and a store 260. Turning to the store 260, the store 260 maintains the resource allocation function 270, one or more local models 280 generated by the local modeling module 230, and resources 290 to be allocated and/or distributed. In other embodiments, the resource allocation system 150 has additional or fewer components than those listed herein. The functions and operations of the various modules may also be interchanged amongst the modules.

The function calculation module 210 maintains the resource allocation function 270. The function calculation module 210 receives definition input from, e.g., one or more client devices 110, to define the resource allocation function 270. Definition input can include what variables are included in the resource allocation function 270 and the interrelationships between the variables. As such, the resource allocation function 270 may be a high-dimensional function that is not explicitly defined. According to subsequent definition inputs, the function calculation module 210 may update or adjust the resource allocation function 270. For example, the function calculation module 210 receives definition to adjust the resource allocation function 270 to add additional variables, e.g., incentives provided to drivers and incentives provided to users in new cities serviced by the transport service system. In other examples, the function calculation module 210 adjusts the interrelationships between variables, wherein the interrelationships define effects of one or more variables on other variables.

The function calculation module 210 evaluates a result for a candidate with the resource allocation function 270. The function calculation module 210 takes a candidate as a vector with values for each of the variables of the resource allocation function 270 and inputs the values into the resource allocation function 270. The various mathematical operations are evaluated with the function calculation module 210 to achieve a result of the resource allocation function 270 according to the input vector. In some implementations, the function calculation module 210 may comprise a plurality of workers, wherein each worker can evaluate a result for a candidate according to the resource allocation function 270 in parallel with the other workers. In practice, to minimize evaluation time, the function calculation module 210 may assign candidates to be evaluated for a result to each worker. The workers proceed with evaluating results according to the resource allocation function 270 in parallel, i.e., simultaneously and/or independent of another worker. The resource allocation function 270 may assign candidates to workers synchronously—waiting till all workers finish a current batch of candidates before assigning a new batch—or synchronously—assigning a new candidate to the worker whenever that worker finishes its evaluation of a previous candidate. When results are evaluated, the function calculation module 210 may tabulate the results in the store 260.

The initialization module 220 initializes candidate. When the resource allocation system 150 is attempting to optimize resource allocation, the initialization module 220 initializes a set of initial candidates. The initial candidates may be randomly selected across the variable domain of the resource allocation function 270. In one embodiment, the initial candidates are selected with a Latin hypercube design. The initialization module 220 provides the set of initial candidates to the function calculation module 210 for evaluating results.

In some embodiments, the initialization module 220 initializes candidates according to particular parameters. In one embodiment, there is a time budget, meaning the resource allocation system 150 has an allotted time to determine an optimal candidate with a highest result among evaluated results. In other embodiments, there is an evaluation budget (in substitution or in addition of the time budget), wherein the evaluation budget limits a number of evaluations prior to selecting the optimal solution. A size of the set of initial candidates—a number of candidates in the set—can depend on the time budget and/or the evaluation budget. Other budgets may further dictate when to select the optimal candidate. In other embodiments, another parameter adjusts a number of local models that are used simultaneously in optimizing the resource allocation function 270, wherein the size of the set of initial candidates depends on this parameter.

The local modeling module 230 maintains a plurality of local models modeling the resource allocation function 270. Each local model comprises a trust region which is a region of the variable domain space. In one embodiment, the trust region is a hypercube according to the dimensionality of the resource allocation function 270. The local modeling module 230 may use a trust region for each local model. In one embodiment, the local modeling module 230 creates a local model for each initial candidate (initialized by the initialization module 220). The local modeling module 230 can center the trust region for the local model around each initial candidate in the variable domain space.

The local modeling module 230 generates a local model representing a prediction of the resource allocation function 270. The local model is generated in the trust region according to one or more evaluations within the trust region. In one embodiment, the local modeling module 230 generates a local model as a Gaussian process posterior distribution according to a Gaussian process regression according to results of evaluated candidates in the local model's trust region. The Gaussian process regression is a stochastic process that supposes that the values of any given set of candidates under the resource allocation function are drawn from a joint multivariate Gaussian distribution. The Gaussian process regression can generally be thought of as a collection of potential functions in the variable domain space. With more evaluations, wherein each evaluation is a result for a candidate, determined within the variable domain space, a Gaussian process posterior distribution of possible functions can be evolved to filter out functions that are not inclusive of the one or more evaluations. When more evaluations are computed (e.g., by the function calculation module 210), the local modeling module 230 can update the local model by adjusting the Gaussian process posterior distribution. Simultaneously optimizing with multiple local models is advantageous in computation efficiency. With a single model, computational costs of updating the local model grows cubically with each additional observation, O(N³) with N being number of observations. Spreading out the evaluations

amongst multiple local models reduces the computational costs, e.g.,

$$M * O ( {( \frac{N}{M} )}^{3} )$$

with M being number of local models operating simultaneously.

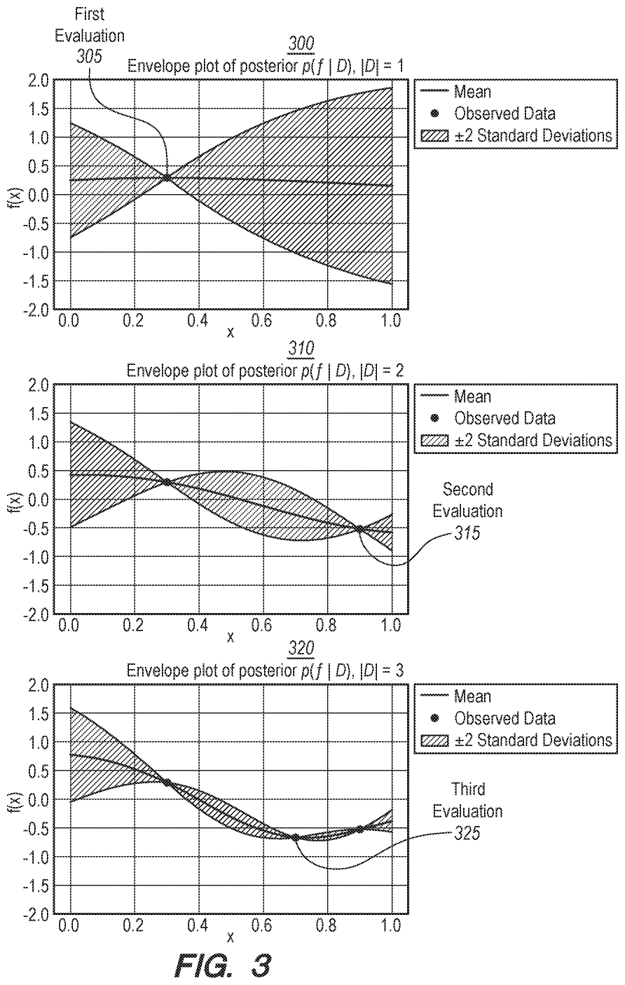

Referring now to FIG. 3, a one-dimensional (1D) example evolution of a Gaussian process posterior distribution according to a Gaussian process is shown. The top graph 300 shows an example 1D variable domain space with a first evaluation 305 is, roughly, f (0.3)=0.25. With the first evaluation 305, the Gaussian process regression filters out random functions over the variable domain space that do not include the first evaluation 305 according to a standard deviation. The resulting Gaussian process distribution is the shaded region which is defined from functions ±2 standard deviations from a mean function. A larger standard deviation would result in a wider spread of the distribution.

In the middle graph 310, there is a second evaluation 315 is, roughly, f (0.9)=−0.5. The Gaussian process posterior distribution is updated accordingly by filtering out more potential functions (previously in the Gaussian process posterior distribution shown in the top graph 300) which do not include the second evaluation 315. Noticeably, the distribution under x=0.3 (where the first evaluation 305 is) is not significantly changed, with the spread only shifting slightly positively. However, the distribution over x=0.3 (where the first evaluation 305 is) looks markedly different.

In the bottom graph 320, there is a third evaluation 325 is, roughly, f(0.7)=−0.7. The Gaussian process posterior distribution evolves once again. As the third evaluation 325 is between the first evaluation 305 and the second evaluation 315, the Gaussian process posterior distribution is tight between the first and the second evaluations 305 and 315, respectively.

In some embodiments when evolving a local model, the local modeling module 230 evolves the trust region of that local model. Evolution of trust regions may include, but is not limited to, shifting the trust region, adjusting a size of the trust region, adjusting a shape of the trust region, another transformation of the trust region, and any combination thereof. In some embodiments, the local modeling module 230 shifts the trust region for that local model. The shifting may be dependent on the evaluations in the trust region. In one implementation, the trust region is recentered around the best evaluation in the trust region, which is an evaluation with a result that is optimal among evaluations in the trust region. In other embodiments, the local modeling module 230 adjusts a size of the trust region. The local modeling module 230 may shrink or expand a size of the trust region. The shrinking or expansion of the trust region may further depend on a utility of a local model. For example, the resource allocation system 150 defines a utility score for each local model according to subsequent evaluations (further detailed in the sampling module 240). A trust region can be shrunk when a utility score is below some threshold while conversely the trust region can be expanded when the utility score is above another threshold or the same threshold for shrinking. In other embodiments, the rules for trust region adjustment may be converse to that described above.

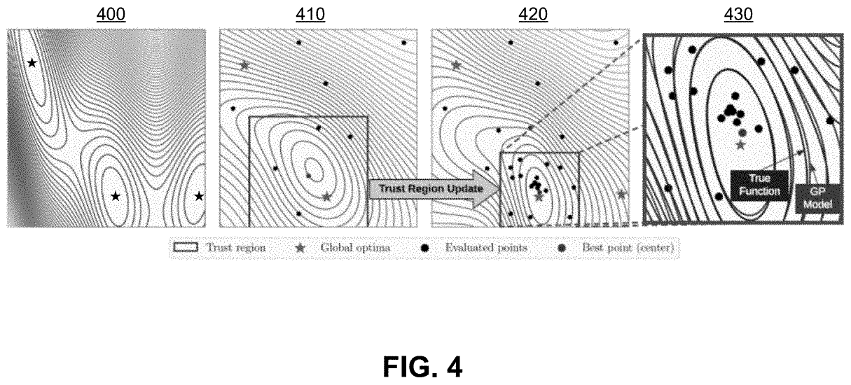

Referring now to FIG. 4, a two-dimensional (2D) example evolution of a trust region for a local model is shown. A first graph 400 shows a 2D true function with three global optima, shown as green stars. The second graph 410 shows eight evaluations, taken from initially evaluated candidates. A trust region, shown as the red square, is centered around the best evaluation so far among the eight evaluations. After further evaluations, e.g., through multiple iterations of Bayesian optimization, the trust region evolves. As exampled in third graph 420, the trust region has shrunk and shifted to be centered around the best evaluation amongst the evaluations in this local model. Noticeably, the local model within the trust region tends towards accuracy to the true function, which is shown in a fourth graph 430. However, outside of the trust region, the accuracy of the local model may suffer. Nonetheless, the benefit of the trust region is that the local model is not required to be fit evaluations outside the trust region which could overfit the local model but rather focuses on fitting the local model within the trust region.

The sampling module 240 identifies one or more candidates to evaluate, e.g., during optimization of the resource allocation function 270. In one embodiment, the sampling module 240 implements Thompson sampling to identify candidates with which to evaluate next according to the resource allocation function 270. According to Thompson sampling, the sampling module 240 samples a function from the Gaussian process posterior distribution of a local model. According to this embodiment, the sampling module 240 identifies a candidate that has optimal value under the sampled function. In one implementation the sampling module 240 provides some or all of the candidates, identified from the local models, to the function calculation module 210 for evaluation. In some embodiments, the sampling module 240 compares the results according to the sampled functions and selects a subset of all the candidates (e.g., one, two, three, etc. candidates are in the subset) from across the local models based on the comparison. Thompson sampling is particularly useful for this task as empirical evidence suggests that it achieves a diverse set of candidate suggestions. Moreover computational cost of Thompson sampling scales favorably with the number of candidates identified from the local models 280.

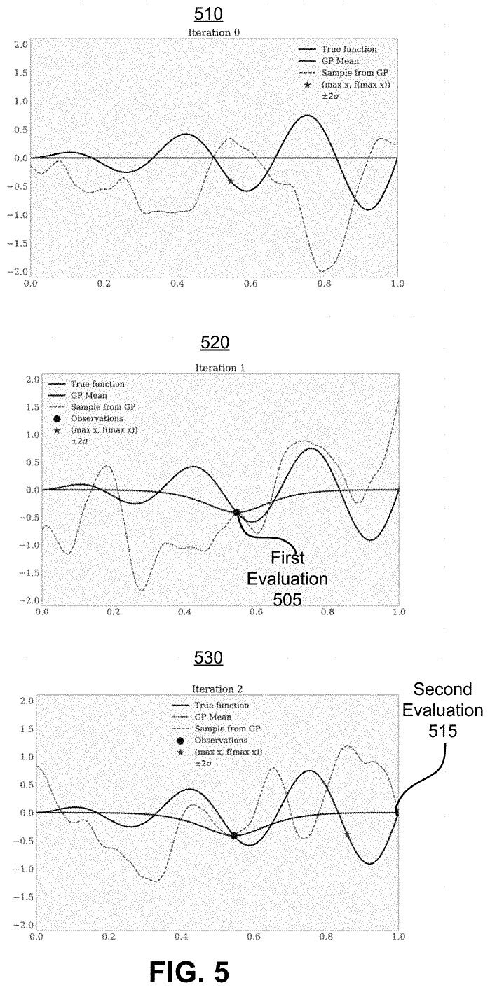

Referring now to FIG. 5, a one-dimensional (1D) example of maximization with a Gaussian process posterior distribution with Thompson sampling is shown. The true function f (x) is a dampened sinusoidal wave illustrated as the black line. In iteration 0, top graph 510, a Gaussian process posterior distribution is centered around function Mean(x)=0. A realization g₀(x) from the Gaussian process posterior distribution is sampled, shown in the red dashed line. From the sampled function, a candidate is identified with the maximal result according to the sampled function, argmax[g₀(x)]. In this example, the candidate point x=0.55 is chosen. A first evaluation 405 of the true result, according to the true function, is evaluated f (0.55)=−0.45. In line with principles described above, the Gaussian process posterior distribution is updated based on the evaluation. Middle graph 520 illustrates the first evaluation 505 at iteration 0 with updated Gaussian process posterior distribution. In this iteration, another function gᵢ (x) is sampled, shown in the red dashed line in the middle graph 520. The next candidate point is identified similarly, argmax[g₁(x)]=1. A second evaluation 515 is calculated with the true function, f (1)=0. The Gaussian process posterior distribution is updated with the second evaluation 515. Bottom graph 530 is iteration 2 with updated Gaussian process posterior distribution with the first evaluation 505 and the second evaluation 515. Repeating the sampling process, candidate point argmax[g₂(x)]=0.87 is identified from sampled function g₂(x) which will be used in the next iteration's evaluation.

In some embodiments, the sampling module 240 evaluates a utility score for each local model. The utility score is a metric for evaluating the efficacy of the local model in finding better solutions. The utility score is thus based on a local model's current set of evaluations and each subsequent evaluation. In a first iteration, the utility score is based on a comparison of the initial evaluations and a first subsequent evaluation. The utility score may be rudimentarily defined as a binary score as to whether a local model has proposed a better solution (i.e., a candidate with a result that is better than a past iteration's evaluations). The utility score can be used to rank the local models providing an indication of how each local model is performing relative to the others. This ranking (and more generally the utility score) can be used when evolving the trust regions.

The resource distribution module 250 selects an optimal solution to determine how to distribute the resources. During the process of optimization of the resource allocation function 270, the various modules collaborate to generate evaluations, each evaluation comprising a vector as input to the resource allocation function 270 and a result as a corresponding output by the resource allocation function 270 with the input. The resource allocation system 150 may tabulate the evaluations. The resource distribution module 250 considers the evaluations and selects an optimal solution with the best result among the list of evaluations. Timing-wise, the resource distribution module 250 may select the optimal solution according to the time budget and/or the evaluation budget described above. For example, a time budget dictates when the resource distribution module 250 selects from the list of solutions. With the evaluation budget, the resource distribution module 250 selects the optimal solution when the evaluation budget is exhausted, i.e., when the number of evaluations specified by the evaluation budget is reached.

According to the selected optimal solution, the resource distribution module 250 distributes the resources 290. The value for each variable in the optimal solution indicates a quantity of a resource to be distributed to the corresponding entity associated with the variable. For example, the vector consists of four total variables: (i) incentives for drivers in City A, (ii) incentives for riders in City A, (iii) incentives for drivers in City B, and (iv) incentives for riders in City B. If the optimal solution is [1, 3, 2, 5], then the corresponding distribution of resources would be as follows: one resource distributed to (i), three resources distributed to (ii), two resources distributed to (iii), and five resources distributed to (iv).

The store 260 stores the resource allocation function 270, the local models 280, and the resources 290. The resource allocation function 270 may be generated and/or updated by various modules and then stored in the store 260. The local models 280 used by the local modeling module 230 and the sampling module 240 may also be generated and/or updated and then stored in the store 260. The resources 290 include storable items such as budget and other monetary incentives, etc. Other resources may not be storable such as time, personnel, etc.

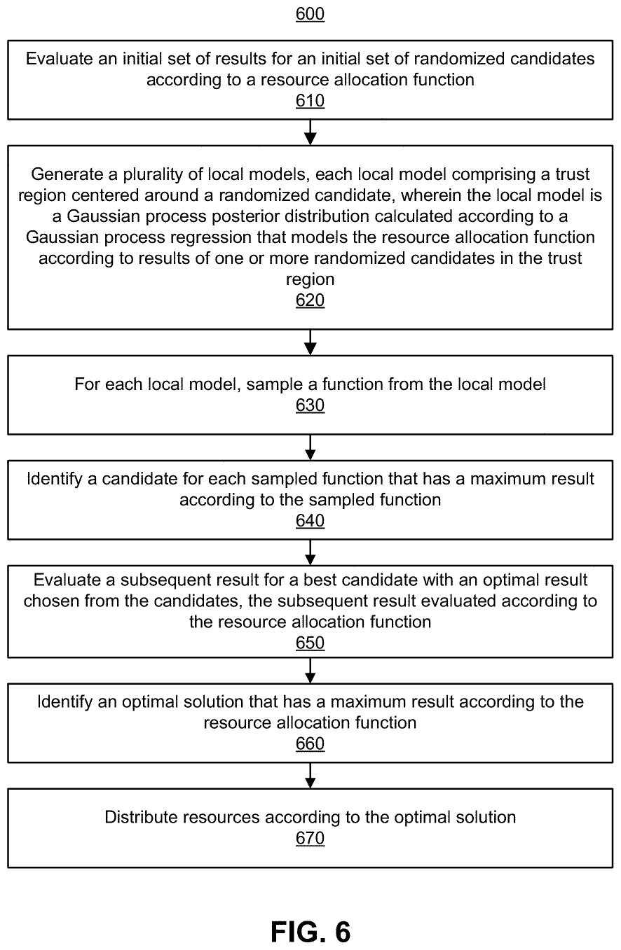

FIG. 6 illustrates a flowchart 600 for resource optimization with simultaneous trust region modeling, in accordance with one or more embodiments. The flowchart 600 for resource optimization may be performed by the resource allocation system 150, i.e., by the various modules of the resource allocation system 150. In other embodiments, other systems may utilize the flowchart 600 for optimizing distribution of resources according to their own resource allocation functions. In other embodiments, more generally, the online system 120 (e.g., a transport service system) performs the steps below. According to various embodiments, the resource allocation system 150 can be any computing system.

At step 610, the resource allocation system 150 evaluates an initial set of results for an initial set of randomized candidates according to a resource allocation function. The resource allocation function can be a higher-dimensional function. In an example with a transport service system, the variables may correspond to various incentives provided to drivers or riders over a plurality of cities. An evaluation of the resource allocation function comprises a candidate used as input to the resource allocation function and a result that is output by the resource allocation function based on the input candidate. The evaluations may be tabulated by the resource allocation system 150.

At step 620, the resource allocation system 150 generates a plurality of local models. Each local model comprises a trust region centered around an initial point. Each local model is a Gaussian process posterior distribution that models the resource allocation function in the trust region. Evaluations in the trust region can include evaluations from the initial set of evaluations or subsequent evaluations.

At step 630, the resource allocation system 150, for each local model, samples a realization from the local model. As described above, the sampling yields a realization sampled from the Gaussian process posterior distribution.

At step 640, the resource allocation system 150 identifies a candidate for each sampled function that has an optimal result over the trust region according to the sampled function. The candidates from each local model may be ranked and filtered at this juncture. For example, the candidates from the various local models are ranked according to their results based on their respective sampled functions. A subset of the candidates (e.g., one, two, etc.) may be chosen by the resource allocation system 150 from the ranking for evaluation with the resource allocation function.

At step 650, the resource allocation system 150 evaluates a subsequent result for a best candidate chosen from the candidates with an optimal result, the subsequent result evaluated according to the resource allocation function. The candidate is input into the resource allocation function to yield a result completing a subsequent evaluation. The subsequent evaluations may be tabulated with past evaluations including the initial evaluations. In additional embodiments, multiple candidates are evaluated, e.g., a subset of candidates selected from the ranking.

At step 660, the resource allocation system 150 identifies an optimal solution that has an optimal result according to the resource allocation function. The optimal solution is chosen or selected from among completed evaluations inclusive of initial evaluations and subsequent evaluations taken at step 650. The optimal solution is a best guess to the true optimal solution of the resource allocation function.

At step 670, the resource allocation system 150 distributes resources according to the optimal solution. The values in the optimal solution are used to dictate distribution of resources in what quantity. Each variable can pertain to a different entity that consumes the resource.

The flowchart 600 may further include additional iterations of sampling. In between iterations, the resource allocation system 150 can update the local models with the subsequent evaluations. This may include updating the Gaussian process posterior distribution with the subsequent evaluations. Updating the local model can also entail updating the trust region by recentering the trust region of a local model around the best so far evaluation selected from that local model and/or adjusting a shape of the trust region (adjusting a size, changing a shape, another transformation, etc.). With updated Gaussian process posterior distributions, another function is sampled in each iteration with the candidate identified according to the same principles describes in steps 630 and 640. The candidates are evaluated resulting in new information, useful for another iteration of updating the local models or considered when identifying the optimal solution at step 660.

### Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A method for optimizing resources of a computing system, the method comprising:
evaluating an initial set of results for an initial set of randomized candidates according to a resource allocation function, the resource allocation function configured to input a plurality of variables and to output a result based on the input;
generating a plurality of local models;
for each local model, sampling a function from the local model;
identifying a candidate for each sampled function that has an optimal result according to the sampled function;
evaluating a subsequent result for a best candidate with an optimal result chosen from the identified candidates, the subsequent result evaluated according to the resource allocation function;
identifying an optimal solution from the initial set of randomized candidates and the best candidate that has an optimal result according to the resource allocation function; and
distributing resources of a computing system according to the optimal solution.

2. The method of claim 1, wherein the resource allocation function is associated with a transport service system with the plurality of variables including, over a plurality of cities, incentives for drivers of each city of the plurality of cities and incentives for riders of each city of the plurality of cities.

3. The method of claim 1, wherein each local model comprises a trust region centered around a randomized candidate, wherein the local model is a Gaussian process posterior distribution calculated according to a Gaussian process regression that models the resource allocation function according to results of one or more randomized candidates in the trust region.

4. The method of claim 3, further comprising:
updating the Gaussian process posterior distribution of a local model according to the subsequent result of the best candidate;
for each local model, sampling a second function from the Gaussian process posterior distribution;
identifying a second candidate for each sampled second function that has an optimal result according to the sampled second function; and
evaluating a second subsequent result for a second best candidate with an optimal result chosen from the identified second candidates, the second subsequent result evaluated according to the resource allocation function,
wherein the optimal solution is identified from the initial set of randomized candidates, the best candidate, and further the second best candidate.

5. The method of claim 3, wherein the trust region is a hypercube.

6. The method of claim 4, further comprising:
for each local model, identifying a best evaluation from one or more candidates in the trust region, the best evaluation having a highest result according to the resource allocation function; and
centering the trust region of the local model around the best evaluation.

7. The method of claim 6, further comprising:
for the local model with the best candidate, evaluating a utility score according to a comparison of the subsequent result for the best candidate to the initial result for the randomized candidate in the trust region; and
adjusting a size of the hypercube of the trust region according to the utility score.

8. The method of claim 7, wherein adjusting the size comprises doubling the size of the hypercube when the utility score is above a threshold indicating the subsequent result improving upon other results of other vectors in the trust region.

9. The method of claim 1, wherein, for each local model, sampling the function from the local model, identifying the candidate for each sampled function that has the optimal result according to the sampled function, and evaluating the subsequent result for each candidate according to the resource allocation function occurs in parallel among the local models.

10. A non-transitory computer-readable storage medium storing instructions that, when executed by a processor, cause the processor to perform operations comprising:
evaluating an initial set of results for an initial set of randomized candidates according to a resource allocation function, the resource allocation function configured to input a plurality of variables and to output a result based on the input;
generating a plurality of local models;
identifying a candidate for each sampled function that has an optimal result according to the sampled function;
evaluating a subsequent result for a best candidate with an optimal result chosen from the identified candidates, the subsequent result evaluated according to the resource allocation function;
identifying an optimal solution from the initial set of randomized candidates and the best candidate that has an optimal result according to the resource allocation function; and
distributing resources of a computing system according to the optimal solution.

11. The non-transitory computer-readable storage medium of claim 10, wherein the resource allocation function is associated with a transport service system with the plurality of variables including, over a plurality of cities, incentives for drivers of each city of the plurality of cities and incentives for riders of each city of the plurality of cities.

12. The non-transitory computer-readable storage medium of claim 10, wherein, each local model comprises a trust region centered around a randomized candidate, wherein the local model is a Gaussian process posterior distribution calculated according to a Gaussian process regression that models the resource allocation function according to results of one or more randomized candidates in the trust region.

13. The non-transitory computer-readable storage medium of claim 12, the operations further comprising:
updating the Gaussian process posterior distribution of a local model according to the subsequent result of the best candidate;
for each local model, sampling a second function from the Gaussian process posterior distribution;
identifying a second candidate for each sampled second function that has an optimal result according to the sampled second function; and
evaluating a second subsequent result for a second best candidate with an optimal result chosen from the identified second candidates, the second subsequent result evaluated according to the resource allocation function,
wherein the optimal solution is identified from the initial set of randomized candidates, the best candidate, and further the second best candidate.

14. The non-transitory computer-readable storage medium of claim 12, wherein the trust region is a hypercube.

15. The non-transitory computer-readable storage medium of claim 14, the operations further comprising:
for each local model, identifying a best evaluation from one or more candidates in the trust region, the best evaluation having a highest result according to the resource allocation function; and
centering the trust region of the local model around the best evaluation.

16. The non-transitory computer-readable storage medium of claim 15, the operations further comprising:
for the local model with the best candidate, evaluating a utility score according to a comparison of the subsequent result for the best candidate to the initial result for the randomized candidate in the trust region; and
adjusting a size of the hypercube of the trust region according to the utility score.

17. The non-transitory computer-readable storage medium of claim 16, wherein adjusting the size comprises doubling the size of the hypercube when the utility score is above a threshold indicating the subsequent result improving upon other results of other vectors in the trust region.

18. The non-transitory computer-readable storage medium of claim 10, wherein, for each local model, sampling the function from the local model, identifying the candidate for each sampled function that has the maximum result according to the sampled function, and evaluating the subsequent result for each candidate according to the resource allocation function occurs in parallel among the local models.

19. A computing system comprising:
a processor; and
a computer-readable storage medium storing instructions that, when executed by the processor, cause the processor to perform operations comprising:
evaluating an initial set of results for an initial set of randomized candidates according to a resource allocation function, the resource allocation function configured to input a plurality of variables and to output a result based on the input;
generating a plurality of local models;
for each local model, sampling a function from the local model;
identifying a candidate for each sampled function that has an optimal result according to the sampled function;
evaluating a subsequent result for a best candidate with an optimal result chosen from the identified candidates, the subsequent result evaluated according to the resource allocation function;
identifying an optimal solution from the initial set of randomized candidates and the best candidate that has an optimal result according to the resource allocation function; and
distributing resources of the computing system according to the optimal solution.

20. The system of claim 19, wherein the resource allocation function is associated with a transport service system with the plurality of variables including, over a plurality of cities, incentives for drivers of each city of the plurality of cities and incentives for riders of each city of the plurality of cities.
